(19) United States
(12) Patent Application Publication
(10) Pub. No.: US 2019/0178282 A1
(43) Pub. Date: Jun. 13, 2019

(54) REACTION WASHER WITH BELLEVILLE SPRING INDUCED RADIALLY INWARD PROGRESSING BOTTOM BITE ACTION AND TIGHTENING AND SECURING SYSTEM

(71) Applicant: The Reaction Washer Company LLC, Springville, UT (US)

(72) Inventors: John D. Davis, Herriman, UT (US); Johannes P. Schneeberger, Brisbane, CA (US)

(73) Assignee: The Reaction Washer Company LLC, Springville, UT (US)

(21) Appl. No.: 16/213,269

(22) Filed: Dec. 7, 2018

Related U.S. Application Data
(63) Continuation-in-part of application No. 16/150,633, filed on Oct. 3, 2018.
Application No. 16/150,633 is a continuation of application No. 14/932,768, filed on Nov. 4, 2015, now Pat. No. 10,107,325.
Application No. 14/932,768 is a continuation-in-part of application No. 15/605,876, filed on May 25, 2017.

(51) Int. Cl. F16B 39/24; F16B 23/00

(52) U.S. Cl. CPC F16B 39/24; F16B 39/26; F16B 23/0061

(57) ABSTRACT

A Belleville reaction washer flattens out while being fully loaded such that its bottom serrations initially contact and bite with their peripheral ends only. Thereby washer slippage is circumvented as the maximum distance to the washer axis offsets eventual increased thread friction and eventual presence of lubricants or paint on the base surface. During washer flattening, the bottom serrations extend their bite radially inward and underneath the nut or bolt head. The Belleville spring action may secure the nut or bolt head on top against inadvertent loosening. In addition, a dual washer stack may include a conical ramp interface for a low overall height and lock washer functionality. Radial torque receive faces remain in plane during washer flattening and receive the torque substantially free of radial force components. A radially slim reaction socket interface may thus be tapered down around them without need for continuous circumferential structural support.

### RELATED APPLICATIONS

The present application is a continuation-in-part of U.S. application Ser. No. 16/150,633, filed Oct. 3, 2018, which is a continuation of U.S. application Ser. No. 14/932,768, filed Nov. 4, 2015, now U.S. Pat. No. 10,107,325, issued Oct. 23, 2018, both of which are incorporated herein by reference. The present application is also a continuation-in-part of U.S. application Ser. No. 15/605,876, filed May 25, 2017, which is incorporated herein by reference. If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

### FIELD OF THE INVENTION

The present invention relates to reaction washers for transferring onto a base surface underneath a circumferentially received reaction torque resulting from actuating a nut or bolt head that is resting on the reaction washer. In particular, the present invention relates to reaction washers with belleville spring induced radially inward progressing bottom bite action and tightening and securing system.

### BACKGROUND

Reaction washers are increasingly employed to transfer onto a base surface underneath a reaction torque that is resulting from actuating a nut or bolt head resting on the reaction washer. Prior Art Reaction washers have either planar arrayed serrations or circumferentially arrayed bite spikes on its bottom side for biting into the base surface underneath in order to transfer the reaction torque onto it.

It is imperative for proper function of the reaction washer that it never slips during the tightening phase during which the axial load on the reaction washer ramps up from an initial minimum to the final tightening load of the nut or bolt head above the reaction washer. To meet this requirement, the slippage resistance in between the reaction washer bottom and the base surface has to be at any time higher than the friction in the respective actuated thread interface. This is difficult to accomplish in a flat surface contact, since common threads have about 60 deg thread flank angle resulting in a normal force on the thread flanks and the corresponding friction force to be at least 13.3% higher than in between a flat surface pair of similar configuration. Hence, and in particular at the beginning of the torque wrench induced tightening phase with minimal loads and consequently in absence of serration biting, the mean diameter of initial bottom serration contact with the base surface is desirably substantially more than 13.3% larger than the mean thread diameter. This may be a suitable minimum for ideal surface conditions in between the reaction washer bottom and the base surface with to the surface conditions, Nevertheless, inadvertent contamination in the thread interface and presence of lubricant, paint or other friction reducing elements on the base surface may occur in field conditions. Therefore, there exists the need for a reaction washer and tightening system that provides an initial bottom serration contact area that is at a minimum and at a maximum distance from the reaction washer axis. The present invention addresses this need.

During initial manual assembly and preloading, sliding resistance in between the nut or bolt head and the reaction washer on one hand and in between the reaction washer and the base surface on the other hand are commonly similar in some prior art reaction washers. This may cause inadvertent sliding of the reaction washer on the base surface and debris or chip build up in the grooves in between bottom serrations during pre-tightening. The debris or chip build up in the grooves may result in an impaired biting action of the bottom serrations during following torque wrench assisted full tightening. Therefore, there exists a need for a reaction washer configuration that prevents inadvertent sliding and bottom serration clogging during initial manual pre-tightening. The present invention addresses also this need.

A prior art reaction washer of the present inventors has circumferential bite spikes or radially oriented serrations that are arrayed along the periphery of the washer bottom. Although such prior art reaction washer provides excellent initial bite, this reaction washer may be required to be within a predetermined height at which its structural stiffness may not be sufficient to completely distribute the load centrally received from the nut or bolt head onto the peripheral bottom serrations or spikes. In that case, the prior art reaction washer may collapse resulting in insufficient bite action towards the final tightening load. Therefore, there exists a need for a reaction washer that provides an initial bottom serration contact area that is at a minimum and at a maximum distance from the reaction washer axis and a final bottom serration contact area that extends radially substantially further inward towards the washer axis than the initial bottom serration contact area. The present invention addresses also this need.

A key function of conventional prior art reaction washers may also be to withhold the nut or bolt head from inadvertently loosening. For that purpose, well known Belleville washers are employed that have a flat conical shape and springily collapse upon receiving the tightening load and maintain resilient contact between the nut or bolt head above and the base surface beneath. A prior art reaction washer of the present inventors incorporates a Belleville body concentrically inside a planar washer portion with the bottom serrations. In this prior art reaction washer, the collapsing and springily resistance of the central Belleville body is limited by the radial extension of it. Therefore, there exists a need for a reaction washer with Belleville configuration that extends substantially into bottom serrations. The present invention addresses also this need.

Reaction washers feature torque receiving structures placed at the washer circumference. To transfer the reaction torque from a reaction socket onto them, the reaction socket commonly features a drain interface that couples in a torque transferring fashion with the torque receiving structures. To keep the coupling between reaction washer and reaction socket compact and within eventually very limited space available around the nut or bolt head to be tightened, it is desirable to have the drain interface and torque receive structures to snuggly fit. On the other hand, the collapsing of a Belleville spring causes angular displacement around its periphery, which may adversely affect a snug fit between torque receiving structures and drain interface. Therefore, there exists a need for a reaction washer and tightening system including drain interface and torque receiving structures that provide a snug fit that is insensitive to the displacement occurring during collapsing of a Belleville spring configuration of the reaction washer. The present invention addresses also this need.

A prior art reaction washer stack of the present inventors provides additionally against inadvertent loosening of a nut or bolt head by the means of a top washer resting via a helical ramp interface on a bottom washer. The helical ramp interface has a ramp pitch that is larger than a thread pitch of the respective nut or bolt such that upon inadvertent rotation of the nut or bolt the top washer is dragged along via its top serrations biting into the nut or bolt head while the bottom washer remains fixed via its bottom serrations biting into the base surface. Since the ramp pitch exceeds the thread pitch, inadvertent rotation in loosening direction of the thread interface increases tension of the nut or bolt head. Nevertheless, such prior art washer stacks require a certain stacking height which may exceed common heights of securing washer systems. Also, such prior art reaction washer stacks do not provide for an initial bottom serration contact area that is at a minimum and at a maximum distance from the reaction washer axis and a final bottom serration contact area that extends radially substantially further inward towards the washer axis than the initial bottom serration contact area. Therefore, there exists the need of a reaction washer stack including a helical ramp functionality that may have an overall stack height that fits within eventual predetermined height limits for washers and at the same time provides an initial bottom serration contact area that is at a minimum and at a maximum distance from the reaction washer axis and a final bottom serration contact area that extends radially substantially further inward towards the washer axis than the initial bottom serration contact area. The present invention addresses also this need.

### SUMMARY

A reaction washer has a Belleville spring body with radial serrations on its shallow conical bottom and top faces. A narrow central serration free rim on washer top and bottom may prevent stress spikes in the serration grooves along the central washer hole during collapsing of the reaction washer at full load.

During initial loading, a minimum serration contact ring along the washer bottom circumference is in contact with the base surface in a maximum distance to the washer axis. Inadvertent eventual increased friction in the tread interface as well as eventual friction reducing elements on the base surface such as paint, dust or lubricant are thereby counter acted and slippage between the reaction washer and the base surface is prevented.

The small initial serration contact area causes also a biting of the bottom serrations at an earliest moment of load increase during tightening phase thereby transitioning earliest on from a pure friction-based contact to a biting contact. As the tightening load increases, the reaction washer continues to collapse and the bottom serrations extend their bite into the base surface towards the washer axis and within the radial extension of the nut or bolt head contact area with the washer top. At a maximum tightening load, the reaction washer is substantially flattened out and eventual top serrations of the reaction washer bite into the nut or bolt head and assist together with Belleville springily washer resistance in withholding it against becoming inadvertently loose.

A number of torque receiving structures are radially outward protruding arrayed along an outer circumference of the reaction washer and with their top substantially flush with the circumference of the conical serration top face. Their bottom is vertically offset from the conical serration bottom face to provide sufficient clearance to a base surface the reaction washer may be biting into while transferring a tightening load from an above nut or bolt head. During collapse of the reaction washer, the reaction washer experiences toroidal deformation causing the torque receiving structures to tilt upwards of about the angle about which a radial washer cross section collapses when flattening out. Torque receiving faces of the torque receiving structures are substantially radially oriented such that the angular deflection of the torque receive structures leaves their orientation substantially unaffected. Consequently, the contact with a drain interface of a reaction socket remains snug during deformation of the reaction socket between relaxed and flattened state and free of peak surface stresses.

As another favorable result of the substantially radially oriented torque receive faces, the reaction torque transfer from the torque transfer flanks of the drain interface onto the torque receiving faces is substantially free of radially acting forces, which in turn eliminates the need for a circumferentially continuous support around the drain interface. The torque inducing structures that provide the torque transfer flanks are consequently tapering downwards on their outside resulting in a wedge shape of them. This further reduces radial access space necessary to transfer the reaction torque onto the reaction washer and clears out eventual debris or paint that may cover the gaps between torque receiving structures. The radially outward open gaps between the torque inducing structures provide for an outward ejection of the debris while the reaction socket is pushed down over the reaction torque receiving interface of the reaction washer.

In a stacked dual washer configuration of the reaction washer, a top washer features on its bottom side a downward facing first multi ramp cone matched by a second upward facing multi ramp cone on the top said of a bottom washer. The conical multi ramp interface provides for a low height of the overall stack while at the same time providing the well-known functionality of a lock washer stack. A serration top face on the top washer has preferably the same Belleville angle than the serration bottom face on the bottom washer such that both top and bottom washer flatten out simultaneously. The toroidal deformation experienced by both top and bottom washers is synchronized across the conical ramp interface.

### BRIEF DESCRIPTION OF THE FIGURES

FIG. 1 is a first perspective cut down view of a first embodiment reaction washer that is supporting a nut above and that is resting on a base.

Also shown is a bottom portion of a reaction socket circumferentially engaging with the reaction washer.

FIG. 2 is the first perspective cut down view of the reaction washer and reaction socket of FIG. 1.

FIG. 3 is a second perspective cut up view of the reaction washer and reaction socket of FIG. 1.

FIG. 4 is the first perspective cut down view of the reaction washer and base of FIG. 1.

FIG. 5 is the second perspective cut up view of the reaction washer of FIG. 1.

FIG. 6 is the first perspective cut down view of a second embodiment reaction washer stack that is supporting a nut above and that is resting on a base. Also shown is a bottom portion of a reaction socket circumferentially engaging with a bottom washer of the reaction washer stack.

FIG. 7 is the first perspective cut down view of the reaction washer and base of FIG. 6.

FIG. 8 is a third perspective exploded down view of the reaction washer of FIG. 6.

FIG. 9 is a fourth perspective exploded down view of the reaction washer of FIG. 6.

### DETAILED DESCRIPTION

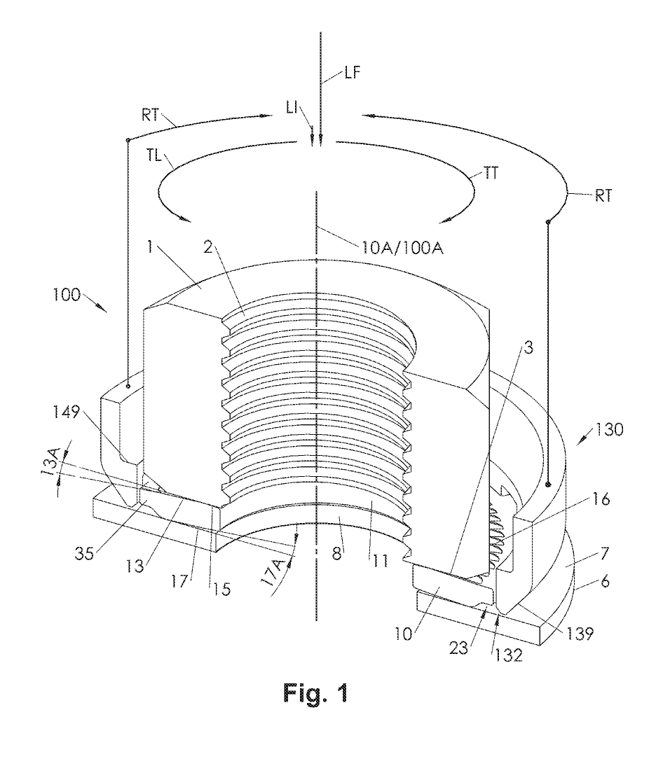

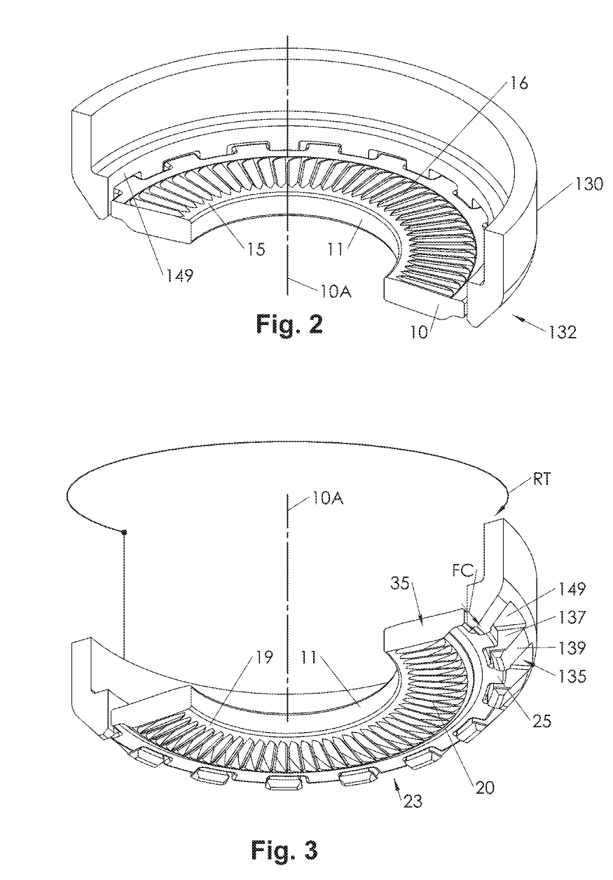

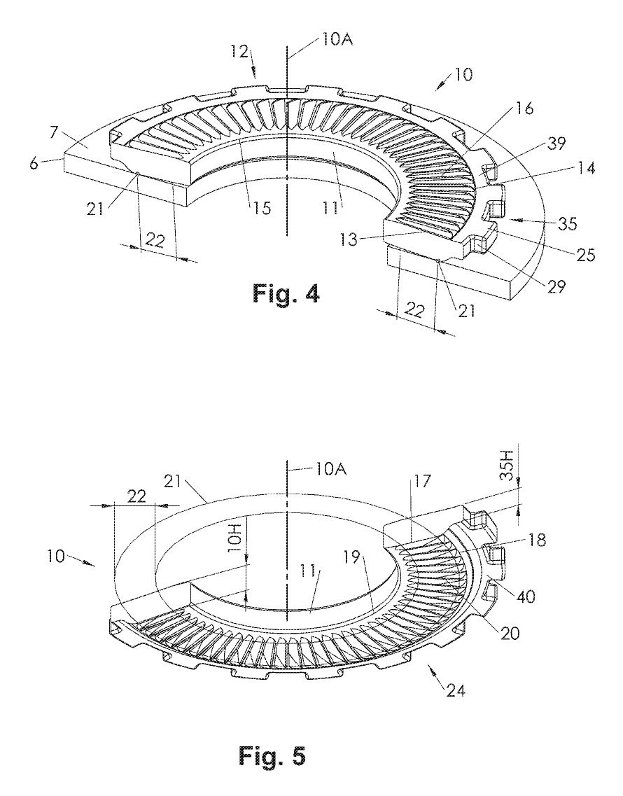

Referring to FIGS. 1-5, a reaction washer 10 of a first embodiment of the invention has a washer axis 10A, a conical top face 13, a conical bottom face 17 and a reaction torque receiving interface 23. The washer axis 10A may coincide with a reaction torque axis 100A around which a reaction torque RT may be transferred onto the reaction torque receiving interface 23 via a drain interface 132 of a reaction socket 130. The reaction torque RT may result from applying an oppositely acting actuation torque TL/TT as a tightening torque TT or a loosening torque TL on an actuation receiving structure 1 such as a nut or bolt head 1. An actuation torque TT/TL may be applied by a well know torque wrench via a well-known actuation socket coupled to the actuation receiving structure 1. Due to the thread pitch of the tightening thread 2, the tightening torque TT may result during tightening in a rotation of the actuation receiving structure 1 and a sliding of the tightening thread 2 in a downward direction and increase from an initial load LI towards final tightening load LF onto base surface 7. During loosening, the loosening torque TL may result of a sliding of the tightening thread 2 in loosening direction and the final tightening load LF being reduced again.

Loads LI and LF in between initial and final state are transferred via a load inducing face 3 at the bottom of the actuation receiving structure 2 onto a conical top face 13 of a reaction washer 10 or in case of the second embodiment of a top washer 55. Top serrations 16 may be circumferentially arrayed on the conical top face 13 and a central serration free top rim 15 may be employed concentrically inside the conical top face 13. In this case and due to a top Belleville angle 13A, the central serration free top rim 15 may be slightly higher than the top serrations 16 such that during load transfer of a minimal load LI, the preferably planar load inducing face 3 may be resting on and sliding around the central serration free top rim 15 in an initial low resistance sliding contact.

During torque wrench tightening with actuation socket and reaction socket 130, rotational resistance between the actuation receiving structure 1 and the reaction washer 10 or top washer 55 is of no substantial functional concern. During initial manual assembly and preloading up to the initial load LI to the contrary, rotational resistance between the actuation receiving structure 1 and the reaction washer 10 or top washer 55 may be of concern. Sliding of the bottom serrations 17 along the base surface 7 may cause material removal from the base surface 7 that may clog the bottom serrations 17 and impair their biting during the following torque wrench assisted tightening. Hence, the initial low resistance sliding contact may be favorably utilized during manual assembly of reaction washer 10 or reaction washer stack 55, 75 and actuation receiving structure 1 and eventual manual establishment of the initial load LI without need to manually hold the reaction washer 10 or reaction washer stack 55, 75 against inadvertent rotation and inadvertent clogging of the bottom serrations 17.

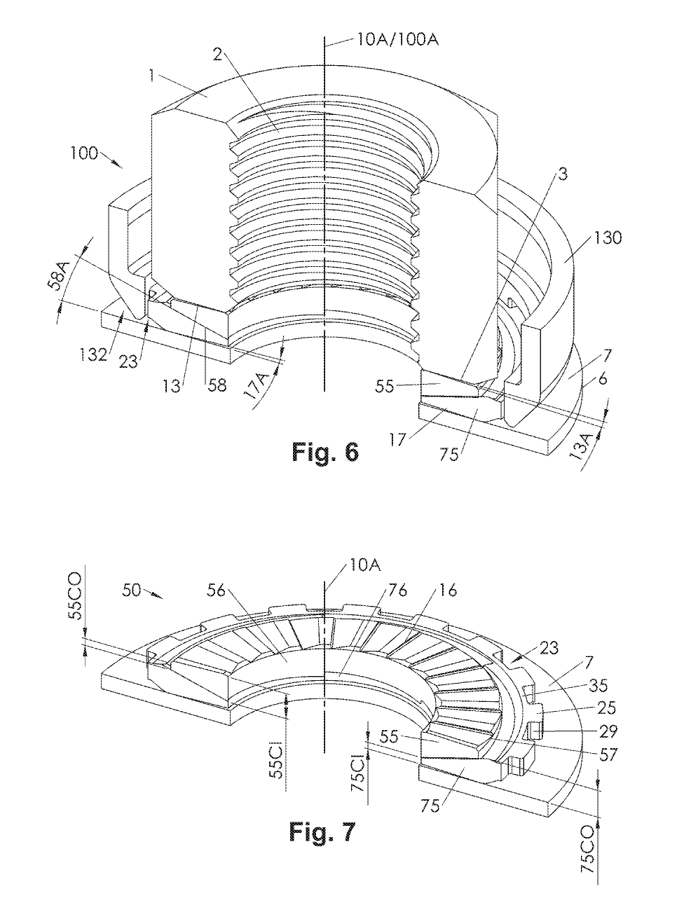

Also referring to FIG. 6 and once the actuation receiving structure 1, the reaction washer 10 or reaction washer stack 55, 75 are assembled with washer holes 11/56, 76 being concentrically with respect to washer axis 10A and torque transfer axis 100A aligned with the base hole 8 and the tightening thread 2, the conical top face 13 or central serration free top rim 15 may be loaded by the load inducing face 3. A reaction socket 130 may be coupled via its drain interface 132 with a reaction torque receiving interface 23 of the reaction washer 10 or reaction washer stack 55, 75 and an actuation socket coupled with the actuation receiving structure 1. For clarity, omitted are well known actuation socket and thread bolt against which the actuation receiving structure 1 in the depicted example of a nut 1 may be screwed on as is well known in the art.

The conical top face 13 may have a number of top serrations 16 that are circumferentially arrayed around the washer axis 10A. The conical bottom face 17 features a number of bottom serrations 20 that are also circumferentially arrayed around the washer axis 10A and that are radially inward extending from a bottom conical face circumference 18. The reaction torque receiving interface 23 has a number of torque receive structures 25 that are radially outward protruding and circumferentially arrayed around the washer axis 10A along an outer circumference of the reaction washer 10 and bottom washer 75.

The reaction washer 10 may have a cross section thickness 10H that is substantially continuous in radial direction at least in between the conical top face 13 and conical bottom face 17. A top Belleville angle 13A of the top conical face 13 and a bottom Belleville angel 17A of the bottom conical face 17 are generally in between 0.1 and 8 degrees such that upon an initial load received via load inducing face 3 on at least one of the conical top face 13 and a top central serration free rim 15, substantially only an initial peripheral serration contact rim 21 of the bottom serrations 20 penetrates into a base surface 6. Preferably, the Belleville angles 13A, 17A are in between 2 and 5 deg. The base surface 6 is part of a base 5 and is underneath the reaction washer 10 and opposing the initial load LI. Upon increasing the initial load LI up to a final tightening load LF, the conical bottom face 17 is flattening out and the bottom serrations 20 are radially inward penetrating the base surface 6 up to a full load serration contact area 22.

The torque receive structures 25 may be part of an actuation flange 35 positioned along a peripheral circumference of the reaction washer 10. The actuation flange 35 may have a flange top 39 and a flange bottom 40. The flange top 39 may be substantially level with and adjacent to a first conical top face circumference 14. The flange bottom 40 is recessed from and adjacent to a second conical bottom face circumference 18. The torque receive structures 25 may be extending in between the flange top 39 and flange bottom 40. The torque receive structures 25 have torque receive faces 29 that are substantially radially inward oriented and aligned with the washer axis 10A such that a reaction torque RT around the washer axis 10A received by the torque receive faces 29 results in a contact force FC that is substantially free of any radial force component.

Part of a reaction torque drain system 100 and while the torque receiving interface 23 is coupled to a drain interface 132 of a reaction socket 130, the torque receive faces 29 are oppositely substantially mating a number of torque transfer flanks 137 provided by torque inducing structures 135 that are circumferentially arrayed around a bottom flange 149 of a reaction socket 130. Since the contact force FC is substantially in circumferential direction and free of any radial force component, the torque inducing structures 135 of the drain interface 132 may extend individually downward from the bottom flange 149 without need of any circumferentially continuous support structure. Moreover, the torque inducing structures 135 may have outer faces 139 that are conically downward and radially inward tapered in direction away from the reaction socket 130. As a favorable result, the drain interface 132 may be fitted with tight spaces around the reaction washer 10. As another favorable result, the drain interface 132 may with the downward wedge-shaped torque inducing structures 135 may easily penetrate into eventual thick debris layers around the torque receiving interface 23 and in between the torque receive structures 25 and may be radially self-cleaning as debris may radially outward eject from in between the torque inducing structures 135. Such debris may be present particularly when having to access a reaction torque receiving interface 23 that has been painted over or otherwise exposed to environmentally induced debris deposits.

The torque receive structures 25 are preferably offset from the conical bottom face 25 such that a hooking nose 141 extending from a distal end of the torque transfer flanks 137 is hooking in underneath the respective torque receive structures 25 immediately above and clear off the base surface 7 while the drain interface 132 is coupled and reaction torque RT transferring to the reaction torque receiving interface 23. The hooking noses 141 may be extending from both transfer flanks 137 of the torque inducing structures 135 so that they may hook underneath the torque receive structures 25 during application of a tightening torque TT or a loosening torque TL on the actuation receiving structure 1.

The reaction washer 10 may further feature on its washer top 12 a central serration free top rim 15 and on its washer bottom 24 a central serration free bottom rim 19. Central serration free top and bottom rims 15, 19 may provide for continuous stress levels that may be at a maximum around the washer hole 11 while the reaction washer 10 is flattened out and may eliminate peak stress areas in the grooves between the serrations 16, 20 along the most stress sensitive areas around the washer holes 11, 56, 76.

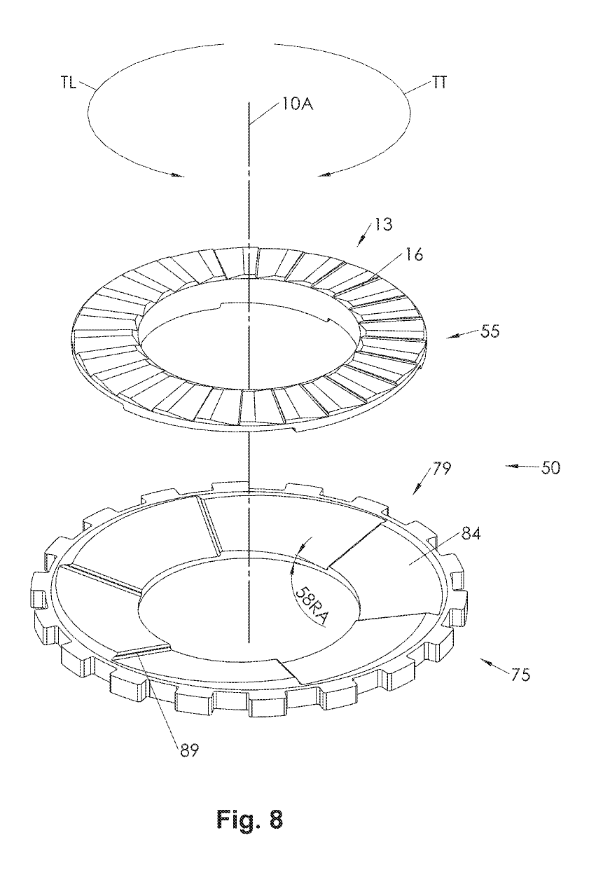

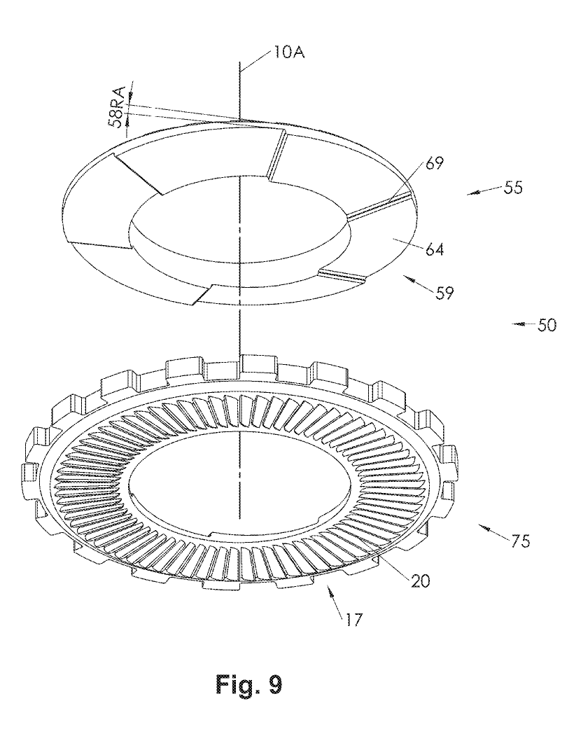

Referring to FIGS. 6-9 and a second embodiment of the invention, the reaction washer 55, 75 may be configured as reaction washer stack 55, 75 including a top washer 55 and a bottom washer 75. The top washer 55 provides thereby the conical top face 13 with preferably the top serrations 16, whereas the bottom washer 75 provides the conical bottom face 17 with the bottom serrations 20. A conical multi ramp interface 58 in between the top and bottom washers 55, 75 is provided by a first multi ramp cone 59 on the bottom of the top washer 55 and a second multi ramp cone 79 on the top of the bottom washer 75. The first multi ramp cone has a number of conical ramp faces 64 that are circumferentially arrayed and interposed by first ramp face steps 69 around the washer axis 10A such that a cross section of the top washer 55 is outwards declining from an inner maximum top washer cross section thickness 55CI towards an out outer top washer circumference 57. There, the top washer 55 has a minimum top washer cross section height 55CO.

The bottom washer 75 provides the reaction torque receiving interface 23, preferably with the actuation flange 35 and torque receiving structures 25. The bottom washer 75 features also the conical bottom face 17 with the circumferentially arrayed bottom serrations 20 that are radially inward extending from the bottom conical face circumference 18. On the top of the bottom washer 75 is a second multi ramp cone 79 that is oppositely mating with its circumferentially arrayed second conical ramp faces 84 interposed by second ramp face steps 89 the first multi ramp cone 59 such that a cross section of the bottom washer 75 is outwards inclining from an inner bottom washer cross section thickness 75CI towards the reaction torque receive interface. In that way, the first multi ramp cone 59 is snug contacting and rotationally blocked by the second multi ramp cone 79 in a thread tightening direction TT and is helically free sliding against the second multi ramp cone 79 in a thread loosening direction TL. The conical multi ramp interface 58 has an interface cone angle 58A in radial direction relative to the washer axis 10A that defines the proportion between respective inner and outer cross section thicknesses 55CI-55CO, 75CI-75CO. The ramp faces 64, 84 have an interface ramp angle 58RA in circumferential direction around the washer axis 10A that defines the pitch of the conical multi ramp interface 58. The interface ramp angle 58RA is larger than the well-known thread pitch of the tightening thread 2 such that during inadvertent rotation of the actuation receiving structure 1 in loosening direction around the washer axis 10A, the top washer 55 may be dragged along via its top serrations 16 biting into the load inducing face 3 and the top washer 55 may ramp up against the bottom washer 75 more than the actuation receiving structure 1 may axially displace away from the base surface 7.

Reaction washer 10 and top and bottom washer 55, 75 may be made of well-known materials such as hardened steel suitable of providing sufficient hardness for the serrations 16, 20 to bite into common materials of actuation receiving structures 1 and bases 6 while at the same time providing sufficient resilience for the Belleville spring action of them. A reaction washer 10 or reaction washer stack 55, 75 may be positioned with its hole 11/(56, 76) over a base hole 8 on a base surface 7. Then the actuation receiving structure 1 such as a nut or bolt may be manually screwed on until the load inducing face 3 is in snug contact with either the conical top face 13 or the central serration free top rim 15 and an initial load LI is established without the reaction washer 10 or washer stack 55, 75 sliding with their bottom serrations 20 in general and the initial peripheral serration contact rim 21 in particular on the base surface 7. During initial loading LI, the reaction washer 10 or reaction washer stack 55, 75 remains substantially in its natural shape without any flattening and the bottom serrations 20 in the bottom Belleville angle 17A to the base surface 7 such that only their very outward end may contact the base surface 7 in a sharp point contact. All the sharp point contacts may circumferentially combine to the initial peripheral serration contact ring 21 that is in a maximum concentric distance around the washer axis 10 and has minimal contact area. Both of these criteria substantially contribute to a successful bite action of the bottom serrations 20 at initial load LI even across lubricant, or paint layers present on the base surface 7.

In a following step, a well-known torque wrench is coupled to the actuation receiving structure 1 via an actuation socket to induce rotation and is coupled with its housing to the reaction torque receiving interface 23 via the reaction socket 130 to transfer and drain reaction torque RT. While a tightening torque TT is applied to the actuation receiving structure 1 and it being screwed downward along the tightening thread 2, the bottom serrations 20 free of debris bite unimpeded into the base surface 7 and drain the corresponding reaction torque RT received via the reaction torque receiving interface 23 into the base 6.

As the initial load LI ramps up to the final tightening load LF, the reaction washer 10 or reaction washer stack 55, 75 flattens out and the bottom serrations 20 gradually bite radially inward towards the washer axis 10A and directly underneath the load inducing face 3 for a straight axial transfer of the full tightening load LF onto the bottom serrations 20 resulting in maximum bite action and rotational resistance of the reaction washer 10 or reaction washer stack 55, 75. Any eventual lubricant or paint layers are thereby also gradually squeezed into the base hole 8 thereby maximizing bite of the bottom serrations 20 even in the eventual presence of lubricant or paint on the base surface 7.

The flattening of the reaction washer 10 or reaction washer stack 55, 75 introduces an angular displacement of the torque receive structures 25. Due to the preferably substantially radial alignment of the torque receive faces 29, the snug contact with torque transfer flanks 137 is maintained and thus surface peak stresses and destructive deformation and galling prevented during washer flattening. In case of the reaction washer stack 55, 75, the flattening of the top washer 55, 75 happens simultaneously and full functionality of the above described initial peripheral serration contact ring 21 is provided. Top and bottom Belleville angles 13A and 17A are preferably equal in particular in case of the second embodiment such that full load serration contact area 22 is provided while at the same time snug contact in the conical multi ramp interface 58 is maintained up to full load LF.

At full predetermined load LF, the eventual top serrations 16 bite into the load inducing face 3 such that the actuation receiving structure 1 is withheld by the reaction washer 10 or reaction washer stack 55, 75 against inadvertent rotation in loosening direction. At the same time, the Belleville resilient load carrying of the reaction washer 10 or reaction washer stack 55, 75, the actuation receiving structure 1 is prevented from axially disengaging from the top serrations 16 in case of severe axial load vibrations as are well known in the art. In case of the reaction washer stack 55, 75 additional safety against inadvertent loosening of the actuation receiving structure 1 is provided by the conical multi ramp interface 58 while at the same time providing the reaction washer stack 55, 75 within a height that is similar to that of the reaction washer 10.

To loosen the actuation receiving structure 1 again, the drain interface 132 may be reengaged with reaction torque receiving interface 23. Any debris accumulated around the reaction torque receiving interface 23 or in between the torque receive structures 25 is displaced by the wedge-shaped torque inducing structures 135 and radially outward ejected via the radially outward open gaps between them. Once reaction socket 130 and actuation socket are coupled a loosening torque TL is applied to a level such that the friction in the tightening thread 2 and between the load inducing face 3 and the conical top face 13 with its eventual biting top serrations 13 is overcome. In case of the reaction washer stack 55, 75, the loosening torque TL may be brought to a level such that the first conical ramp faces 64 fully slide around their respective second conical ramp faces 84 and plunge axially down over the ramp face steps 89 into the next following conical ramp face 84, which may sufficiently stretch the thread bolt for it to become loose at that time. If not, then the actuation receiving structure 1 may be destructively removed in a well-known fashion.

Accordingly, the scope of the present invention described in the Figures and Specification above is set forth by the following claims and their legal equivalent:

I/We claim:

1. A reaction washer comprising:
a. a washer axis;
b. a conical top face;
c. a conical bottom face comprising a number of bottom serrations that are circumferentially arrayed around said washer axis and that are radially inward extending from a bottom conical face circumference; and
d. a reaction torque receiving interface comprising a number of torque receive structures that are radially outward protruding and circumferentially arrayed around said washer axis along an outer circumference of said reaction washer.

2. The reaction washer of claim 1, wherein said conical top face comprises a number of top serrations that are circumferentially arrayed around said washer axis.

3. The reaction washer of claim 1, further comprising a cross section thickness that is substantially continuous in radial direction at least in between said conical top face and said conical bottom face.

4. The reaction washer of claim 1, wherein said conical top face and said conical bottom face comprise a Belleville angle of in between 0.1 and 8 degrees such that:
a. upon an initial load received on at least one of said conical top face and a top central serration free rim, substantially only an initial peripheral serration contact ring of said bottom serrations penetrates into a base surface that is underneath said reaction washer and that is opposing said initial load; and
b. upon an increasing said initial load up to a final tightening load, said conical bottom face is flattening out and said bottom serrations are radially inward penetrating said base surface up to a full load serration contact area.

5. The reaction washer of claim 1, wherein at least one of said torque receive structures comprises a torque receive face that is substantially radially inward oriented and aligned with said washer axis such that a torque around said washer axis received by said torque receive face results in a contact force that is substantially free of any radial force component.

6. A reaction washer comprising:
a. a washer axis;
b. a washer top comprising:
i. a central serration free top rim; and
ii. a conical top face that is outward surrounding said central serration free rim and that comprises a number of circumferentially arrayed top serrations;
c. a washer bottom comprising:
i. a central serration free bottom rim; and
ii. a conical bottom face that is outward surrounding said central serration free bottom rim and that comprises a number of circumferentially arrayed bottom serrations; and
d. an actuation flange that is positioned along a peripheral circumference of said reaction washer, said actuation flange comprising:
i. a flange top that is substantially level with and adjacent to a first circumference of said conical top face;
ii. a flange bottom that is recessed from and adjacent to a second circumference of said conical bottom face; and
iii. a number of radially outward protruding torque receive structures that are arrayed along an outer circumference of said actuation flange substantially concentrically with respect to said washer axis and extending in between said flange top and said flange bottom.

7. The reaction washer of claim 6, further comprising a cross section thickness that is substantially continuous in radial direction at least in between said serrated top face and said serrated bottom face.

8. The reaction washer of claim 6, wherein said conical top face and said conical bottom face comprise a Belleville angle of in between 0.1 and 8 degrees such that:
a. upon an initial load received on at least one of said conical top face and a top central serration free rim, substantially only an initial peripheral serration contact ring of said bottom serrations penetrates into a base surface that is underneath said reaction washer and that is opposing said initial load; and
b. upon an increasing said initial load up to a final tightening load, said conical bottom face is flattening out and said bottom serrations are radially inward penetrating said base surface up to a full load serration contact area.

9. The reaction washer of claim 6, wherein at least one of said torque receive structures comprises a torque receive face that is substantially radially inward oriented and aligned with said washer axis such that a torque around said washer axis received by said torque receive face results in a contact force that is substantially free of any radial force component.

10. A reaction washer stack comprising:
a. a washer axis;
b. a top washer comprising:
i. a conical top face comprising a number of circumferentially arrayed top serrations; and
ii. a first multi ramp cone at the bottom of said top washer, said first multi ramp cone comprising a number of conical ramp faces that are circumferentially arrayed around said washer axis such that a cross section of said top washer is outwards declining towards an outer circumference of said top washer; and
c. a bottom washer comprising:
i. a reaction torque receiving interface comprising a number of torque receiving structures that are radially outward protruding and circumferentially arrayed around said washer axis along an outer circumference of said reaction washer;
ii. a conical bottom face comprising a number of bottom serrations that are circumferentially arrayed around said washer axis and that are radially inward extending from a bottom conical face circumference; and
iii. a second multi ramp cone on the top of said bottom washer, wherein said second multi ramp cone is oppositely mating said first multi ramp cone such that a cross section of said bottom washer is outwards inclining towards said reaction torque receive interface such that said first multi ramp cone is snug contacting and rotationally blocked by said second multi ramp cone in a thread tightening direction, and such that said top multi ramp cone is helically free sliding against said second multi ramp cone in a thread loosening direction.

11. The reaction washer of claim 10, wherein said conical top face and said conical bottom face comprise a Belleville angle of in between 0.1 and 8 degrees such that: a. upon an initial load received on at least one of said conical top face and a top central serration free rim, substantially only an initial peripheral serration contact ring of said bottom serrations penetrates into a base surface that is underneath said bottom washer and that is opposing said initial load; and b. upon an increasing said initial load up to a final tightening load, said conical bottom face is flattening out and said bottom serrations are radially inward penetrating said base surface up to a full load serration contact area.

12. The reaction washer of claim 10, wherein at least one of said torque receive structures comprises a torque receive face that is substantially radially inward oriented and aligned with said washer axis such that a torque around said washer axis received by said torque receive face results in a contact force that is substantially free of any radial force component.

13. The reaction washer of claim 10, wherein said reaction torque receiving interface further comprises:
i. a flange top that is substantially level with and adjacent to a first circumference of said top multi ramp cone; and
ii. a flange bottom that is recessed from and adjacent to a second circumference of said serration bottom face; and wherein said torque receiving structures are radially outward protruding and extending in between said flange top and said flange bottom.

14. A reaction torque drain system comprising:
a. a reaction torque transfer axis;
b. a reaction washer comprising:
i. a conical bottom face comprising a number of bottom serrations that are circumferentially arrayed around said washer axis and that are radially inward extending from a first conical face circumference; and
ii. a reaction torque receiving interface comprising a number of torque receiving structures that are radially outward protruding and circumferentially arrayed around said washer axis along an outer circumference of said reaction washer, wherein at least one of said radially outward protruding torque receiving structures comprises a torque receive face that is substantially aligned with said reaction torque transfer axis such that a reaction torque around said reaction torque transfer axis received by said torque receive face results in a contact force that is substantially free of any radial force component; and
c. a drain interface of a reaction socket comprising a number of torque inducing structures that are circumferentially arrayed around said reaction torque transfer axis and that are individually extending downward from a bottom flange of said reaction socket, at least one of said torque inducing structures comprising a torque transfer flank that is oppositely substantially mating said torque receive face while said reaction socket drain interface is coupled with said reaction torque receiving interface such that said torque inducing structure is exposed to said contact force in substantially circumferential direction with respect to said reaction torque transfer axis.

15. The reaction torque drain system of claim 14, wherein said torque inducing structures comprise an outer face that is conically downward and radially inward tapered in direction away from said reaction socket.

16. The reaction torque drain system of claim 14, wherein said torque receiving structures are offset from said conically bottom face and wherein at least one of said torque inducing structures comprises a hooking nose that is extending from a distal end of said torque transfer flank such that while said drain interface is coupled and reaction torque transferring to said reaction torque receiving interface and said reaction washer is resting on a base surface, said hooking nose is hooking in underneath one of said torque receive structures and immediately above said base surface.
